(19) United States
(12) Patent Application Publication
(10) Pub. No.: US 2023/0324978 A1
(43) Pub. Date: Oct. 12, 2023

(54) POWER SAVING FEATURE CONTROLS FOR ADD-IN CARDS

(71) Applicant: HEWLETT-PACKARD DEVELOPMENT COMPANY, L.P., Spring, TX (US)

(72) Inventors: Jui Ching Chang, Taipei City (TW); Chien-Cheng Su, Taipei City (TW); Chao-Wen Cheng, Taipei City (TW); Wen-Bin Lin, Taipei City (TW)

(21) Appl. No.: 17/714,325

(22) Filed: Apr. 6, 2022

(51) Int. Cl. G06F 1/3287; G06F 1/3237

(52) U.S. Cl. CPC G06F 1/3287; G06F 1/3237

(57) ABSTRACT

In example implementations, a computing device is provided. The computing device includes an expansion interface that includes a plurality of slots. A first add-in card is connected to a first slot of the plurality of slots. A second add-in card is connected to a second slot of the plurality of slots. The computing device includes a processor communicatively coupled to the expansion interface. The processor is to detect that the first add-in card is compatible with a power savings control signal and that the second add-in card is not compatible with the power savings control signal, disable the power savings control signal to the second slot, and transmit the power savings control signal to the first slot when the first add-in card goes into a power savings mode.

### BACKGROUND

Computing devices can be used to execute various applications and programs. A processor is deployed in a computing device to execute the applications and programs. The computing device can have additional components that can help execute the applications, such as memory, graphics processors, and the like.

The computing device may include expansion interfaces to allow additional components to be added to the computing device. The additional components may add functionality to the computing device. For example, the additional components may provide more powerful graphics, larger amounts of memory, additional communication interfaces, and the like.

### BRIEF DESCRIPTION OF THE DRAWINGS

FIG. 1 is a block diagram of an example computing device to control power savings features of add-in cards connected to an expansion interface of the present disclosure;

FIG. 2 is another block diagram of another example computing device to control power savings features of add-in cards connected to an expansion interface of the present disclosure;

FIG. 3 is a block diagram that illustrates using an system management bus (SMBus) to determine compatibility with a power savings control signal of the present disclosure;

FIG. 4 is a block diagram that illustrates using general purpose input/output (GPIO) channels to determine compatibility with a power savings control signal of the present disclosure;

FIG. 5 is a flow chart of an example method to control power savings features of add-in cards connected to an expansion interface of the present disclosure; and

FIG. 6 is an example non-transitory computer readable storage medium storing instructions executed by a processor to control power savings features of add-in cards connected to an expansion interface of the present disclosure.

### DETAILED DESCRIPTION

Examples described herein provide a computing device and method to control power savings features of add-in cards connected to an expansion interface. As discussed above, computing devices can be used to execute various applications and programs. A computing device may include expansion interfaces to allow additional components to be added to the computing device. The additional components may add functionality to the computing device. For example, the additional components may provide more powerful graphics, larger amounts of memory, additional communication interfaces, and the like.

An example of the additional components may include add-in cards (AICs) that can be connected to an expansion interface. Some AICs may support active state power management to reduce power consumption when not being used. However, some AICs may not support active state power management.

Some expansion interfaces may use power savings control signals that are sent to all AICs connected to the slots of the expansion interface. As a result, if an AIC connected to a slot of the expansion interface is not compatible with the power savings control signal, the AIC may go into a power savings mode and be unable to wake up from the power savings mode. As a result, the functionality of the AIC may be disrupted, leading to an undesirable user experience.

The present disclosure provides a method to selectively transmit the power savings control signal to particular slots of the expansion interface. Thus, the power savings control signal may be transmitted to AICs connected to the expansion interface that have a power savings feature that is compatible with the power savings control signal. By selectively sending the power savings control signal, AICs connected to the expansion interface that are not compatible with the power savings control signal may continue to operate uninterrupted.

In an example, the expansion interface may scan the slots of the expansion interface to identify the AICs connected to the expansion interface and to determine the compatibility of the AICs with the power savings control signal. The power savings control signal may then be selectively transmitted to the slots with the AICs that are compatible with the power savings control signal.

In an example, the expansion interface may use a system management bus (SMBus) to identify the AICs. The identification of the AICs may be compared to a white list and/or a black list to determine whether the AICs are compatible with the power savings control signal. In an example, the expansion interface may use a general purpose input/output (GPIO) channel to perform an impedance check to determine if the AICs are compatible with the power savings control signal.

Thus, the computing device of the present disclosure may take advantage of active state power management features on newer AICs, while allow the use of older AICs that do not have the active state power management feature. Thus, older AICs can continue to be used in computing devices with the newer AICs without potential errors or failures.

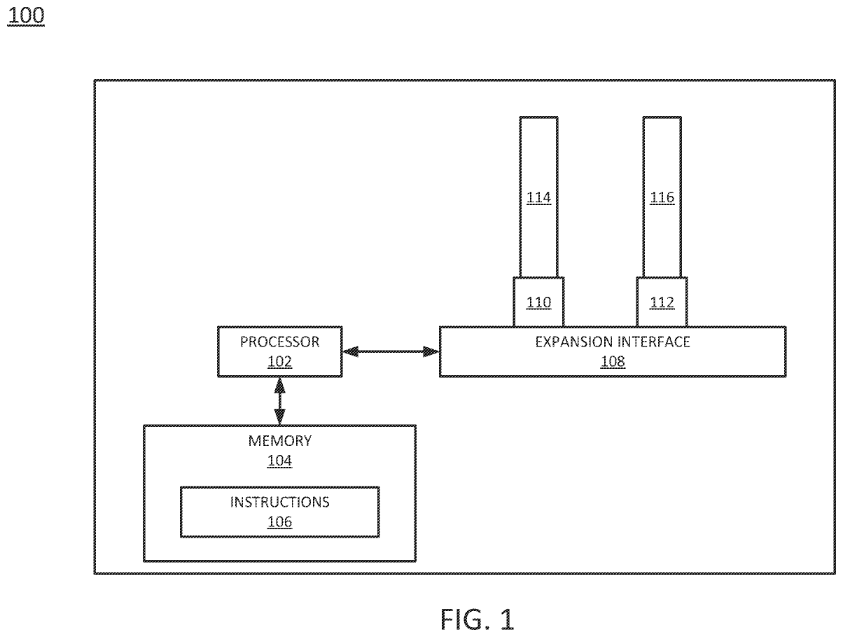

FIG. 1 illustrates an example computing device 100 to control power savings features of add-in cards connected to an expansion interface of the present disclosure. In an example, the computing device 100 may be a desktop computer, a laptop computer, a tablet computer, and the like.

It should be noted that computing device 100 has been simplified for ease of explanation. Although various example components are illustrated in FIG. 1, it should be noted that the computing device 100 may include additional components that are not shown. For example, the computing device 100 may include input/output devices (e.g., a display, a monitor, a keyboard, a mouse, a trackpad, and the like), a power supply, various interfaces (e.g., a universal serial bus (USB) interface), communications interfaces (e.g., a wired or wireless communication interface such as WiFi, Ethernet, and the like), solid state drive, a hard disk drive, and so forth.

In an example, the computing device 100 may include a processor 102, a memory 104, and an expansion interface 108. The processor 102 may be communicatively coupled to the memory 104 and the expansion interface 108. The processor 102 may access the memory 104 to access data and/or instructions 106 and to control operation of the expansion interface 108.

The memory 104 may be any type of non-transitory computer readable medium. For example, the memory 104 may be a hard disk drive, a solid state drive, a non-volatile memory express (NVMe) card, a random access memory (RAM), a read-only memory (ROM), and the like. The memory 104 may store the instructions 106. The instructions 106 may be executed by the processor 102 to perform the functions described herein to control power savings features of add-in cards connected to the expansion interface 108.

The expansion interface 108 may include slots 110 and 112. Although two slots are illustrated in FIG. 1, it should be noted that the expansion interface 108 may include any number of slots. The expansion interface 108 may allow add-in cards 114 and 116 to be connected to the slots 110 and 112, respectively, to provide added functionality to the computing device 100. For example, the expansion interface 108 may allow for easy addition of graphics processors, additional memory, network interfaces, and the like, for the computing device 100.

In an example, the add-in card 114 and the add-in card 116 may be graphics cards to provide additional graphics processing capabilities for the computing device 100. The add-in card 114 may be a graphics card that has active state power management (ASPM) features and may be connected to the slot 110. For example, the add-in card 114 may have various power savings modes (e.g., L0s stand-by mode and L1 deep idle mode). The various power savings modes can be controlled by activation and pausing of a reference clock that controls operation of the add-in cards 114 and 116 connected to the slots 110 and 112 of the expansion interface 108.

The add-in card 116 may also be a graphics card, but an older graphics card that does not support or have the ASPM features. For example, the add-in card 116 may have a stand-by mode, but may not have the deep idle mode (L1). Thus, if the reference clock to the add-in card 116 is paused, the add-in card 116 may not be able to wake from the paused reference clock and may malfunction during operation.

The present disclosure allows the processor 102 to identify the compatibility of the add-in cards 114 and 116 with a power savings control signal. If the add-in card 114 or 116 is not compatible with the power savings control signal, the ability of the add-in card 114 or 116 to receive the power savings control signal (e.g., a clk_req signal as discussed below) may be disabled. For example, a channel to carry the power savings control signal to the slot 110 or 112 may be temporarily disconnected or disabled. Thus, the processor 102 may still generate and transmit the power savings control signal to the slot 110 or 112 that is connected to an add-in card 114 or 116 that is compatible with the power savings control signal.

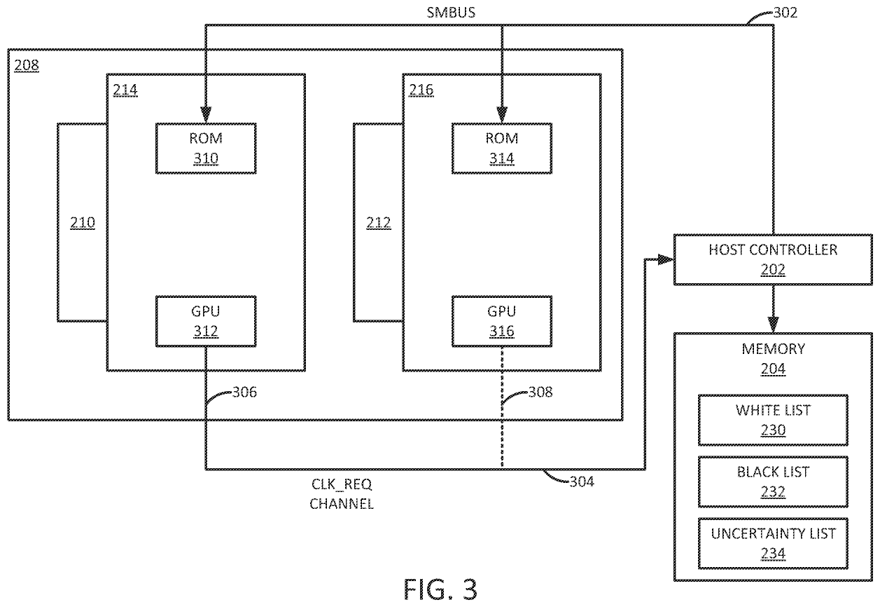

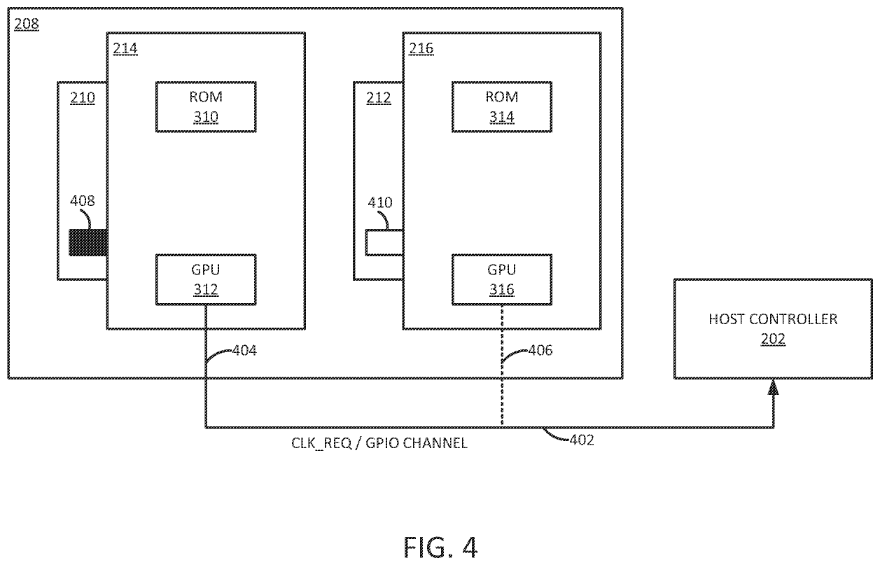

In an example, the processor 102 may obtain compatibility information from the add-in cards 114 and 116. FIGS. 3 and 4 illustrate different methods of how the compatibility information can be obtained. In FIG. 1, the add-in card 114 may be determined to be compatible with the power savings control signal and the add-in card 116 may be determined to not be compatible with the power savings control signal. As a result, the processor 102 may disable the power savings control signal to the slot 112 connected to the add-in card 116.

At a later time, the add-in card 114 may send a request for the power savings control signal to activate a power savings mode. The processor 102 may generate and transmit the power savings control signal to the slot 110. However, the slot 112 may not receive the power savings control signal since the power savings control signal to the slot 112 has been disabled.

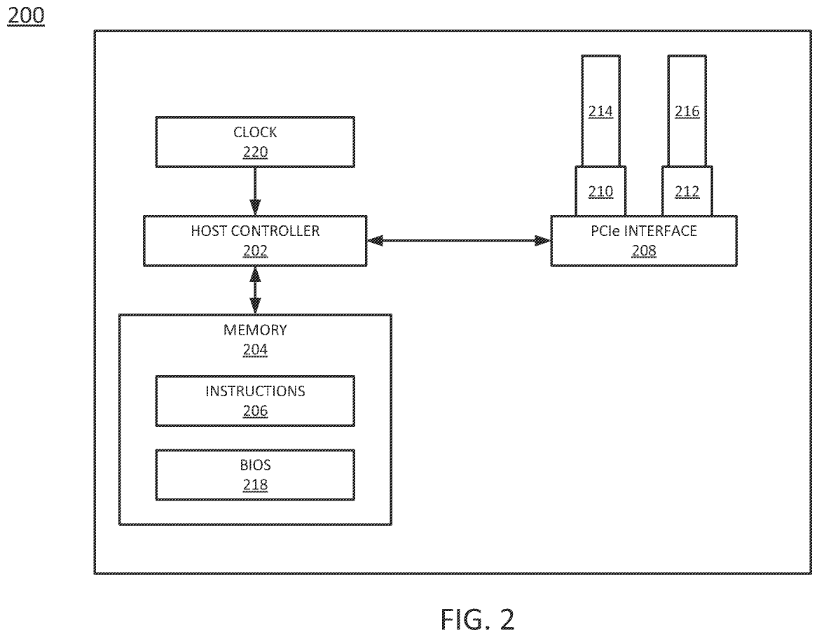

FIG. 2 illustrates another block diagram of another example computing device 200 to control power savings features of add-in cards connected to an expansion interface of the present disclosure. In an example, the computing device 200 may be a desktop computer, a laptop computer, a tablet computer, and the like.

It should be noted that computing device 200 has been simplified for ease of explanation. Although various example components are illustrated in FIG. 2, it should be noted that the computing device 200 may include additional components that are not shown. For example, the computing device 200 may include input/output devices (e.g., a display, a monitor, a keyboard, a mouse, a trackpad, and the like), a power supply, various interfaces (e.g., a universal serial bus (USB) interface), communications interfaces (e.g., a wired or wireless communication interface such as WiFi, Ethernet, and the like), solid state drive, a hard disk drive, and so forth.

The computing device 200 may include a host controller 202, a memory 204, a peripheral component interconnect express (PCIe) interface 208, and a system clock 220. The host controller 202 may be communicatively coupled to the memory 204, the expansion interface 208, and the system clock 220. The host controller 202 may access the memory 204 to access data and/or instructions 206 and to control operation of the expansion interface 208 and the system clock 220.

The memory 204 may be any type of non-transitory computer readable medium. For example, the memory 204 may be a hard disk drive, a solid state drive, a non-volatile memory express (NVMe) card, a random access memory (RAM), a read-only memory (ROM), and the like. The memory 204 may store the instructions 206 and a BIOS 218. The instructions 206 may be executed by the processor 202 to perform the functions described herein to control power savings features of add-in cards connected to the expansion interface 208.

In an example, the BIOS 218 may be used to obtain compatibility information of add-in cards 214 and 216 connected to the PCIe interface 208 via slots 210 and 212, respectively. The BIOS 218 may then selectively disable the power savings control signal (e.g., a clk_req signal) to the slot 210 or 212 connected to an add-in card 214 or 216 that is not compatible with the power savings control signal. The BIOS 218 may obtain the compatibility information and disable the appropriate slots 210 or 212 during a boot sequence of the computing device 200.

As used herein, a BIOS refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of the computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

The PCIe interface 208 may include slots 210 and 212. Although two slots are illustrated in FIG. 2, it should be noted that the PCIe interface 208 may include any number of slots. The PCIe interface 208 may allow add-in cards 214 and 216 to be connected to the slots 210 and 212, respectively, to provide added functionality to the computing device 200. For example, the PCIe interface 208 may allow for easy addition of graphics processors, additional memory, network interfaces, and the like, for the computing device 200.

In an example, the add-in card 214 and the add-in card 216 may be graphics cards to provide additional graphics processing capabilities for the computing device 200. The add-in card 214 may be a graphics card that has active state power management (ASPM) features and may be connected to the slot 210. For example, the add-in card 214 may have various power savings modes (e.g., L1 sub-states and new L1.1 and L1.2 lower power sub-state modes). The various power savings modes can be controlled by activation and pausing of a reference clock signal received from the system clock 220 that controls operation of the add-in cards 214 and 216 connected to the slots 210 and 212 of the PCIe interface 208.

The add-in card 216 may also be a graphics card, but an older graphics card that does not support or have the ASPM features. For example, the add-in card 216 may have a stand-by mode, but may not have the deep idle mode (e.g., L1.1 and L1.2 lower power sub-state modes). Thus, if the reference clock signal from the system clock 220 to the add-in card 216 is paused, the add-in card 216 may not be able to wake from the paused reference clock and may malfunction during operation.

The present disclosure allows the host controller 202 to identify the compatibility of the add-in cards 214 and 216 with the clk_req signal. The clk_req signal may be used to restart the reference clock signal from the system clock 220 to a particular slot 210 or 212 when the add-in card has been placed in a deep idle mode using the clk_off signal to pause the system clock 220. Pausing the reference clock signal may cause an add-in card with ASPM features to enter a deep idle mode L1. The clk_req signal may be requested to reactivate the reference clock signal from the system clock 220. If the add-in card 214 or 216 is not compatible with the clk_req signal, the ability of the add-in card 214 or 216 to receive the clk_req signal may be disabled. For example, a channel for the clk_req signal to the particular slot 210 or 212 may be temporarily disconnected or disabled. Thus, the host controller 202 may still generate and transmit the clk_req signal to the slot 210 or 212 that is connected to an add-in card 214 or 216 that is compatible with the clk_req signal.

In an example, the host controller 202 may obtain compatibility information from the add-in cards 214 and 216. FIGS. 3 and 4 illustrate different methods of how the compatibility information can be obtained. In FIG. 2, the add-in card 214 may be determined to be compatible with the power savings control signal and the add-in card 216 may be determined to not be compatible with the power savings control signal. As a result, the host controller 202 may disable the clk_req signal to the slot 212 connected to the add-in card 216.

At a later time, the add-in card 214 may send a request for the power savings control signal to activate a power savings mode. The processor 202 may generate and transmit a clk_off signal to the slot 210. The clk_off signal may pause the reference clock signal from the system clock 220 to the slot 210. Thus, the add-in card 214 may go into a deep idle mode (e.g., L1.1 and L1.2 lower power sub-state modes). However, the clk_off signal is not sent to the slot 212, and the reference clock signal is allowed to run continuously or freely on the slot 212 connected to the add-in card 216.

The add-in card 214 may then want to wake from the deep idle mode and send a request for a clk_req signal to restart the reference clock signal from the system clock 220. The host controller 202 may generate and transmit the clk_req signal to the slot 210 to wake the add-in card 214 and restart the reference clock signal from the system clock 220. However, the clk_req signal is not sent to the slot 212. Thus, the ability of the slot 212 to receive the power savings control signals is disabled and the add-in card 216 can operate freely without interruption that could be caused by the power savings control signals generated and received by the slot 210.

FIGS. 3 and 4 illustrate different examples of how the compatibility information can be obtained from the add-in cards 214 and 216. FIG. 3 illustrates an example that uses the system management bus (SMBus) to obtain identification information that is then compared to a white list, black list, and/or uncertainty list. FIG. 4 illustrates an example where compatibility information is obtained by performing an impedance check.

Referring to FIG. 3, FIG. 3 illustrates a more detailed block diagram of the PCIe interface 208 and the add-in cards 214 and 216. In an example, the add-in card 214 may include a read-only memory (ROM) 310 and a graphical processing unit (GPU) 312. The add-in card 216 may include ROM 314 and a GPU 316.

The host controller 202 may be connected to the ROM 310 and ROM 314 via a system management bus (SMBus) 302. The ROM 310 may store identification information of the add-in card 214. The ROM 314 may store identification information of the add-in card 216. The identification information may include a model name, a model number, a serial number, feature information, and the like.

In an example, the host controller 202 may obtain the identification information from the add-in card 214 and the add-in card 216 via the SMBus 302. The host controller 202 may then compare the identification information to a white list 230, a black list 232, and/or an uncertainty list 234 stored in the memory 204. The white list 230 may store a list of add-in cards that are known to be compatible with the power savings control signal (e.g., the clk_req signal). The black list 232 may store a list of add-in cards that are known to be not compatible with the power savings control signal. The uncertainty list 234 may store a list of add-in cards whose compatibility with the power savings control signal is uncertain or unknown.

The host controller 202 may then compare the identification information for the add-in card 214 to the white list 230, the black list 232, and the uncertainty list 234 to determine the compatibility information for the add-in card 214. For example, if the identification information for the add-in card 214 is found in the white list 230, the add-in card 214 may be compatible with the power savings control signal. However, if the identification information for the add-in card 214 is found in the black list 232 or the uncertainty list 234, the add-in card 214 may not be compatible with the power savings control signal.

The same process may be repeated with the identification information of the add-in card 216 to determine the compatibility of the add-in card 216 with the power savings control signal. In an example, the memory 204 may just store the white list 230. For example, if the identification information for the add-in card 214 or 216 is not found in the white list 230, it may be determined that the add-in card 214 or 216 is not compatible with the powers savings control signal.

In an example, the white list 230, the black list 232, and the uncertainty list 234 may be periodically updated. For example, as new models and types of add-in cards are developed, the compatibility of the new models of add-in cards with the power savings control signal may be tested. The identification information may then be stored in the white list 230, the black list 232, or the uncertainty list 234 based on the compatibility test results.

As noted above, the add-in card 214 may be determined to be compatible with the power savings control signal, and the add-in card 216 may be determined to not be compatible with the power savings control signal. Thus, the host controller 202 may temporarily disable a channel 308 (shown in dashed lines in FIG. 3). With the channel 308 disabled, when the host controller 202 transmits a clk_off or clk_req signal over a clk_req channel 304, the add-in card 216 may not receive the signals and may continue to operate uninterrupted.

The clk_req channel 304 may be connected from the host controller 202 to the GPU 312 and the GPU 316. The clk_req channel 304 may have an independently controllable channel 306 to the GPU 312 of the add-in card 214 and an independently controllable channel 308 to the GPU 316 to the add-in card 216. Thus, the host controller 202 may temporarily disable the channel 308, while allowing a clk_req signal to be sent to the GPU 312 via the clk_req channel 304 and 306.

FIG. 4 illustrates a more detailed block diagram of the PCIe interface 208 and the add-in cards 214 and 216. As illustrated in FIG. 3, the add-in cards 214 and 216 may include ROM 310 and 314, respectively, and GPUS 312 and 316, respectively.

FIG. 4 illustrates a clk_req pin 408 in the slot 210 and a clk_req pin 410 in the slot 212. Add-in cards that support ASPM features may be connected to the clk_req pin 408 or 410. In the example illustrated in FIG. 4, the add-in card 214 is has the ASPM feature. Thus, the add-in card 214 is connected to the clk_req pin 408 as shown by a solid colored pin. The add-in card 216 is not compatible with the ASPM feature. As a result, the add-in card 216 is not connected to the clk_req pin 410 as shown by an open pin.

In an example, a channel 402 may be connected to the host controller 202. The channel 402 to may also include independently controllable channels 404 and 406. The channel 404 may be connected to the GPU 312, and the channel 406 may be connected to the GPU 316.

The channel 402 may serve as a general purpose input/output (GPIO) channel and the clk_req channel. For example, before a reset, the channel 402 may serve as a GPIO channel. After the reset is performed and the channels 404 and 406 are selectively enabled or disabled based on the compatibility information, the channel 402 may serve as the clk_req channel.

In an example, the add-in cards 214 and 216 may be connected and loaded into the respective slots 210 and 212 of the PCIe interface 208. The host controller 202 may perform a platform reset to reset the GPIO pad, while the system, or computing device, resumes from a S3 (stand-by), S4 (hibernate), or S5 (soft off) state associated with the power savings states of the ASPM feature.

The host controller 202 may then perform an impedance check over the GPIO channel 402. If the clk_req pin is connected, the check may return a value to the host controller 202. Thus, for the add-in card 214, the impedance check may return a value since the clk_req pin 408 is connected. If the clk_req pin is not connected, the check may return an undefined or indefinite response as the pin is open. Thus, for the add-in card 216, the impedance check may return an undefined value since the clk_req pin 410 is not connected and is open.

Based on the impedance check, the host controller 202 may determine that the add-in card 214 is compatible with the power savings control signal and that the add-in card 216 is not compatible with the powers savings control signal. The host controller 202 may temporarily disable the channel 406 (as shown by dashed lines in FIG. 4). With the channel 406 disabled, when the host controller 202 transmits a clk_off or clk_req signal over a clk_req channel 402, the add-in card 216 may not receive the signals and may continue to operate uninterrupted. However, the clk_off and clk_req signals may be received by the add-in card 214 via the channels 404 and 402 to enter and wake from the various power savings states associated with the ASPM feature.

Thus, the present disclosure may control the power savings feature of an add-in card connected to the expansion interface or PCIe interface. The processor or host controller may determine compatibility information (e.g., via identification information compared to a white list or an impedance check) and selectively disable channels to a slot connected to add-in cards that are determined not to be compatible with the power savings control signal. As a result, add-in cards that are compatible may receive and use the power savings control signal to cycle between the various power savings modes, while the add-in cards that are not compatible may operate freely uninterrupted.

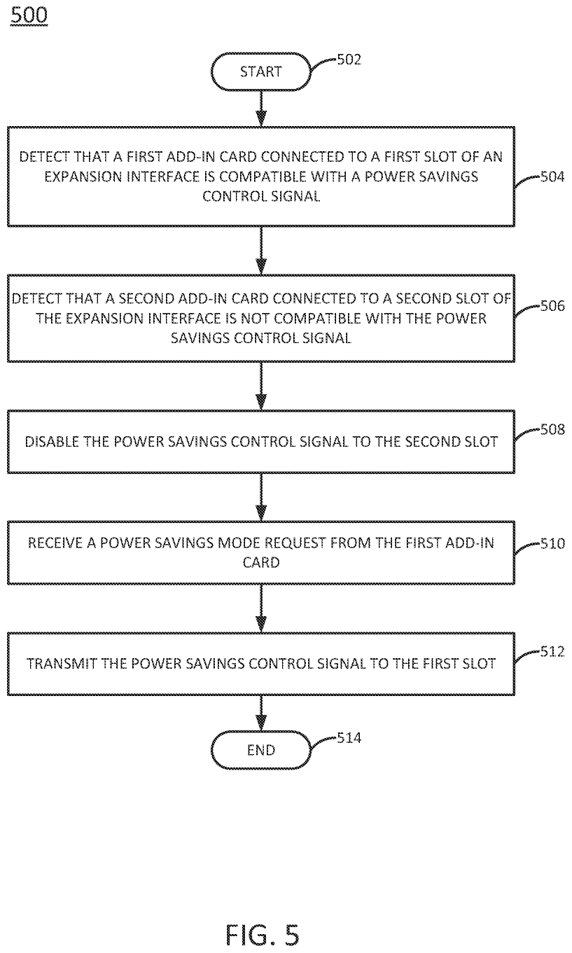

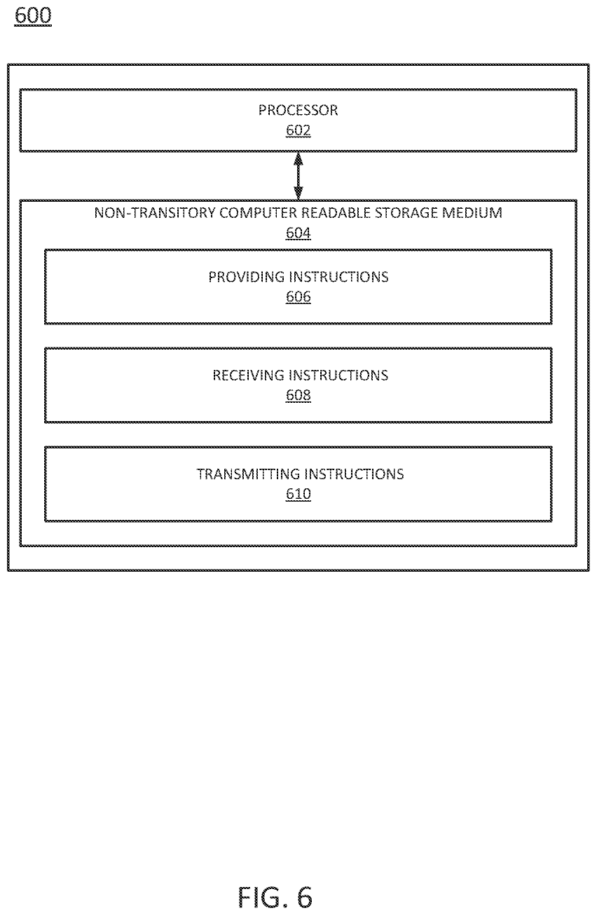

FIG. 5 illustrates a flow diagram of an example method 500 for controlling power savings features of add-in cards connected to an expansion interface of the present disclosure. In an example, the method 500 may be performed by the computing device 100 illustrated in FIG. 1, the computing device 200 illustrated in FIG. 2, or the apparatus 600 illustrated in FIG. 6, and described below.

At block 502, the method 500 begins. At block 504, the method 500 detects that a first add-in card connected to a first slot of an expansion interface is compatible with a power savings control signal. For example, the first add-in card may be a graphics card that has ASPM features. The expansion interface may be a PCIe interface that uses clk_off and clk_req signals to cycle between power savings modes for the ASPM feature of the add-in card.

At block 506, the method 500 detects that a second add-in card connected to a second slot of the expansion interface is not compatible with the power savings control signal. For example, the second add-in card may be an older graphics card that does not have the ASPM features. Thus, the second add-in card may not be compatible with the powers savings control signals, such as the clk_off and clk_req signals used by the PCIe interface to cycle between the power savings modes associated with the ASPM features.

In an example, the compatibility of the first add-in card and the second add-in card may be detected via identification information obtained over the SMBus or via an impedance check, as described above in FIGS. 3 and 4. For example, the identification information may be compared to a white list, a black list, and/or an uncertainty list. If the identification information for an add-in card is found in the white list, the add-in card may be detected to be compatible with the power savings control signal. If the identification information is not found in the white list, or is found in the black list or uncertainty list, the add-in card may be detected to not be compatible with the power savings control signal.

The impedance check may check a clk_req pin in the slots of the PCIe interface. For example, if the add-in card is compatible with the power savings control signal, the clk_req pin may be connected to the add-in card. When the impedance check is performed, a non-zero value may be returned. However, if the add-in card is not compatible with the power savings control signal, the clk_req pin may not be connected to the add-in card. Thus, when the impedance check is performed, an undefined value or error signal may be returned as the clk_req pin is open.

At block 508, the method 500 disables the power savings control signal to the second slot. In an example, the BIOS may perform the compatibility detection during a boot sequence of the computing device. The BIOS may then disable the channel that feeds the clk_req signal to the second slot temporarily. Thus, when the processor generates and transmits the clk_req signal over the clk_req channel, the second slot may be prevented from receiving the clk_req signal.

At block 510, the method 500 receives a power savings mode request from the first add-in card. For example, the computing device may be booted after the power savings control signal to the second slot is disabled. During operation of the computing device, the first add-in card may go into a power savings mode (e.g., an L1.1 and L1.2 lower power sub-state modes).

At block 512, the method 500 transmits the power savings control signal to the first slot. For example, the processor may generate and transmit a clk_off signal to pause the reference clock that controls operation of the slots on the PCIe interface. However, since the channel to the second slot is disabled, the second slot may not receive the clk_off signal. As a result, the reference clock for the second add-in card may continue to operate freely or uninterrupted. The first slot may receive the clk_off signal and pause the clock allowing the first add-in card to enter the power savings mode.

At a later time, when the first add-in card is to wake to operate again, the first add-in card may send a request for the clk_req signal. The clk_req signal may reactivate the reference clock for the first slot to allow the first add-in card to wake and begin operating again. However, since the channel to the second slot is temporarily disabled, the second slot may not receive the clk_req signal, and the second add-in card may continue to operate normally. At block 514, the method 500 ends.

FIG. 6 illustrates an example of an apparatus 600. In an example, the apparatus 600 may be the apparatus 100 or 200. In an example, the apparatus 600 may include a processor 602 and a non-transitory computer readable storage medium 604. The non-transitory computer readable storage medium 604 may include instructions 606, 608, and 610 that, when executed by the processor 602, cause the processor 602 to perform various functions.

In an example, the instructions 606 may include providing instructions. For example, the instructions 606 may provide a reference clock to a first slot of an expansion interface connected to a first add-in card that is compatible with a clk_off signal and a clk_req signal and a second slot of the expansion interface connected to a second add-in card that is not compatible with the clk_off signal and the clk_req signal. For example, the first add-in card and the second add-in card may be graphics cards. The first add-in card may have active state power management (ASPM) features that can function properly in response to the reference clock being paused by the clk_off signal or reactivated by the clk_req signal. The second add-in card may not have the ASPM features and may fail if the reference clock is paused.

The instructions 608 may include receiving instructions. For example, the instructions 608 may receive a request from the first add-in card to enter a power savings mode.

The instructions 610 may include transmitting instructions. For example, the instructions 610 may transmit the clk_off signal to the first slot to pause the reference clock for the first slot while the reference clock continues to operate for the second slot. The reference clock can be reactivated when the add-in card returns to an operating state using a clk_req signal.

The clk_off and the clk_req signal to the second slot may be disabled through a process that identifies the second add-in card is not compatible with the clk_off signal and the clk_req. For example, the identification information of the add-in cards may be compared to a white list and/or a black list to determine compatibility. The identification information may be obtained by gathering information over the SMBus or by performing an impedance check, as described above.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A computing device, comprising:
an expansion interface comprising a plurality of slots;
a first add-in card connected to a first slot of the plurality of slots;
a second add-in card connected to a second slot of the plurality of slots; and
a processor communicatively coupled to the expansion interface, wherein the processor is to:
detect that the first add-in card is compatible with a power savings control signal and that the second add-in card is not compatible with the power savings control signal;
disable the power savings control signal to the second slot; and
transmit the power savings control signal to the first slot when the first add-in card goes into a power savings mode.

2. The computing device of claim 1, wherein the expansion interface comprises a peripheral component interconnect express (PCIe) interface.

3. The computing device of claim 2, wherein the processor comprises a host controller of the PCIe interface, wherein the host controller retrieves identification information from the first add-in card and the second add-in card via a system management bus.

4. The computing device of claim 3, wherein the host controller compares the identification information to a white list, a black list, and an uncertainty list.

5. The computing device of claim 4, wherein a match of the identification information of the first add-in card is found in the white list to detect that the first add-in card is compatible with the power savings control signal.

6. The computing device of claim 4, wherein a match of the identification information of the second add-in card is found in the black list or the uncertainty list to detect that the second add-in card is not compatible with the power savings control signal.

7. The computing device of claim 2, further comprising:
a clk_req channel communicatively coupled from the plurality of slots to the processor to request a clk_req signal.

8. The computing device of claim 2, wherein each slot of the plurality of includes a clk_req pin, and the processor is to detect that the first add-in card is compatible with the power savings control signal and that the second add-in card is not compatible with the power savings control signal via an impedance check on respective clk_req pins of the first slot and the second slot.

9. The computing device of claim 1, wherein the first add-in card comprises a graphics card with active state power management and the second add-in card comprises a graphics card without active state power management.

10. The computing device of claim 1, wherein the power savings control signal is a clk_off signal to pause a reference clock that controls operation of the first add-in card and the second add-in card and a clk_req signal to reactivate the reference clock.

11. A method, comprising:
detecting, by a processor, that a first add-in card connected to a first slot of an expansion interface is compatible with a power savings control signal;
detecting, by the processor, that a second add-in card connected to a second slot of the expansion interface is not compatible with the power savings control signal;
disabling, by the processor, the power savings control signal to the second slot;
receiving, by the processor, a power savings mode request from the first add-in card; and
transmitting, by the processor, the power savings control signal to the first slot.

12. The method of claim 11, wherein detecting that the first add-in card is compatible with the power savings control signal comprises:
retrieving, by the processor, identification information over a system management bus;
comparing, by the processor, the identification information to a white list; and
determining, by the processor, that the identification information is included in the white list.

13. The method of claim 11, wherein disabling comprises:
allowing, by the processor, a reference clock of the second slot to run continuously.

14. The method of claim 11, wherein detecting that the first add-in card is compatible with the power savings control signal comprises:
performing, by the processor, an impedance check on a clk_req pin of the first slot; and
detecting, by the processor, that the clk_req pin is not open.

15. The method of claim 11, wherein detecting that the second add-in card is not compatible with the power savings control signal comprises:
performing, by the processor, an impedance check on a clk_req pin of the second slot; and
detecting, by the processor, that the clk_req pin is open.

16. The method of claim 15, wherein disabling the power savings control signal to the second slot comprises:
performing, by the processor, a platform reset before the power savings control signal to the second slot is disabled.

17. A non-transitory computer readable storage medium encoded with instructions which, when executed, cause a processor of a computing device to:
provide a reference clock to a first slot of an expansion interface connected to a first add-in card that is compatible with a clk_off signal and a clk_req signal and to a second slot of the expansion interface connected to a second add-in card that is not compatible with the clk_off signal and the clk_req signal;
receive a request from the first add-in card to enter a power savings mode; and
transmit the clk_off signal to the first slot to pause a reference clock for the first slot while the reference clock continues to operate for the second slot.

18. The non-transitory computer readable storage medium of claim 17, wherein the instructions, when executed, further cause the processor to:
obtain identification information of the first add-in card and the second add-in card via a system management bus.

19. The non-transitory computer readable storage medium of claim 18, wherein the instructions, when executed, further cause the processor to:
compare the identification information of the first add-in card and the second add-in card to a white list of devices that are compatible with the clk_off signal and the clk_req signal to determine that the first add-in card is compatible with the clk_off signal and the clk_req signal and that the second add-in card is not compatible with the clk_off signal and the clk_req signal.

20. The non-transitory computer readable storage medium of claim 17, wherein the instructions, when executed, further cause the processor to:
perform an impedance check on a clk_req pin on the first slot and the second slot to determine that the first add-in card is compatible with the clk_req signal and that the second add-in card is not compatible with the clk_off signal and the clk_req signal.
